(19) United States
(12) Patent Application Publication
(10) Pub. No.: US 2025/0379641 A1
(43) Pub. Date: Dec. 11, 2025

(54) SYSTEM AND METHOD FOR AT LEAST ONE OF DETERMINING A REFERENCE POLARIZATION, PERFORMING CHANNEL ESTIMATION OF AN ENVIRONMENT AND SENSING THE ENVIRONMENT

(71) Applicant: HUAWEI TECHNOLOGIES CO., LTD., Shenzhen (CN)

(72) Inventors: Mohamed KAMOUN, Boulogne Billancourt (FR); Yun Yaw Chu, Boulogne Billancourt (FR); Mustapha AMARA, Boulogne Billancourt (FR)

(21) Appl. No.: 19/300,872

(22) Filed: Aug. 15, 2025

Related U.S. Application Data
(63) Continuation of application No. PCT/EP2023/053951, filed on Feb. 16, 2023.

(51) Int. Cl. H04B 7/10; H04B 17/309

(52) U.S. Cl. CPC H04B 7/10; H04B 17/309

(57) ABSTRACT

The present disclosure relates to a system for at least one of determining a reference polarization, performing channel estimation of an environment and sensing the environment. The system comprises a controller, one or more processors, a polarizer device, and a device. The device is configured to wirelessly emit a first electromagnetic wave such that the first electromagnetic wave impinges on the polarizer device and on a second device, and a second electromagnetic wave such that the second electromagnetic wave impinges on the polarizer device and on the second device. The present disclosure relates to a method for at least one of determining a reference polarization, performing channel estimation of an environment and sensing the environment.

### CROSS-REFERENCE TO RELATED APPLICATIONS

This application is a continuation of International Application No. PCT/EP2023/053951, filed on Feb. 16, 2023, the disclosure of which is hereby incorporated by reference in its entirety.

### TECHNICAL FIELD

The present disclosure relates to a system and a method for at least one of determining a reference polarization, performing channel estimation of an environment and sensing the environment.

### BACKGROUND

A rapid evolution of mobile telecommunication has been witnessed, shifting from voice centric communication usages to predominantly data centric services usages. The next generation(s) of telecommunication will further pursue the increase of data channel capacity and coverage for more users at an unseen scale.

### SUMMARY

The next generation(s) of telecommunication may also include new types of services such as sensing. Sensing technologies are traditionally designed as a standalone function through dedicated systems such as radar, or imagery processing based systems. However, the concept of sensing integrated with communication may be seen as potential disruptive feature.

A goal of combining sensing and communication features may be to reach a mutual benefit. On one hand communication signals may be used for sensing purposes and may help to achieve high accuracy localization, activity sensing or environment scouting. On the other hand sensing features may be used in order to increase the quality of service and the performance of communication with better interference mitigation, channel prediction or beam steering/focusing/alignment.

The design of waveforms of wireless communication signals and their processing may focus on the quality of the signal and its level at the output of a radio-frequency (RF) chain. For sensing applications, a significant amount of information related to the environment may be neglected, distorted or completely squeezed in non-useful information. The first cause of this situation is that radio-frequency (RF) signals propagate as electromagnetic (EM) waves (EM fields) that are three dimensional vectors. All the interactions between the environment and the RF signals in the field domain (with a dominant electromagnetic field component in wireless communications). With most antennas employed in wireless communication devices, these interactions are squeezed out since converted into single dimensional signals represented by currents or voltages.

Empowering wireless communication devices with sensing applications requires hardware and algorithm tools to perform measurements of impinging electromagnetic waves. Polarimetry which consist in measuring the full impinging electromagnetic field is a capability to enable such application. These features may be embedded in the specific imagery setups or apparatus with controlled deployment in terms of location and orientation. To the majority of mobile devices, such facilities are not available; since devices may be in any location and orientation. Without a common reference for spatial orientation and for antenna polarization at transmitting and receiving wireless nodes, polarimetry sensing is difficult to achieve due to the spatial ambiguities to resolve.

In view of the above, this disclosure aims to provide a system for at least one of determining a reference polarization, performing channel estimation of an environment and sensing the environment. Channel estimation may comprise without restriction any functionality such as environment perception, environment analysis, digital twin synthesis, scene identification, object detection, object localization, object identification, channel sounding, propagation parameters estimation for communication purpose. An objective of this disclosure may be to provide a system allowing for a device, which is configured to emit electromagnetic waves and does not have self-awareness of the polarization of its emittable electromagnetic waves and/or their spatial orientation, to determine a reference polarization, perform channel estimation of an environment, in which the device is arranged, and/or sense the environment. An objective of this disclosure may be to provide a system allowing a device, which is configured to emit electromagnetic waves, to perform polarimetry sensing without the device needing to have self-awareness of the polarization of its emittable electromagnetic waves and/or their spatial orientation. For example polarimetry sensing may comprise polarimetry acquisition for sensing and/or communication. This may include a reference polarimetry acquisition and/or a polarimetry of the sensed environment through reflected electromagnetic waves.

These and other objectives are achieved by the solution of this disclosure as described in the independent claims. Advantageous implementations are further defined in the dependent claims.

A first aspect of this disclosure provides a system for at least one of determining a reference polarization, performing channel estimation of an environment and sensing the environment. The system comprises a controller, one or more processors, a polarizer device, and a device. The device is configured to wirelessly emit a first electromagnetic wave such that the first electromagnetic wave impinges on the polarizer device and on a second device, and a second electromagnetic wave such that the second electromagnetic wave impinges on the polarizer device and on the second device. The controller is configured to control the polarizer device to change a polarization of the first electromagnetic wave impinged on the polarizer device to a first polarization, such that the first electromagnetic wave with the first polarization impinges on the second device. The controller is configured to control the polarizer device to change a polarization of the second electromagnetic wave impinged on the polarizer device to a second polarization, such that the second electromagnetic wave with the second polarization impinges on the second device. The one or more processors are configured to determine the reference polarization, perform the channel estimation and/or sense the environment based on the first electromagnetic wave with the first polarization and the second electromagnetic wave with the second polarization. That is, the one or more processors are configured to do at least one of the following based on the first electromagnetic wave with the first polarization and the second electromagnetic wave with the second polarization: determine the reference polarization, perform the channel estimation and sense the environment.

In other words, the system allows for the device to determine a reference polarization, perform channel estimation of the environment, in which the device is arranged, and/or sense the environment. In other words, the system allows the device to perform polarimetry sensing. For this, the device does not need to have self-awareness of the polarization of its emitted electromagnetic waves and/or their spatial orientation. For this no fully controlled environment with a priori known parameters is required. In addition, the device does not require special hardware components to illuminate a target in multi-electromagnetic polarities. Namely, the polarizer device is present in the system for generating an electromagnetic wave with a first polarization and an electromagnetic wave with a second polarization. Thus, the system allows the device to lack necessary features in software and/or hardware to be enabled to perform polarimetry sensing.

The term “electromagnetic wave” may be referred to as “electromagnetic field”. The terms “first electromagnetic wave with the first polarization” and “second electromagnetic wave with the second polarization” may be referred to as “resulting (first) electromagnetic wave with the first polarization” and “resulting (second) electromagnetic wave with the second polarization”. The device may be referred to as “first device”.

The first polarization (to which the polarization of the first electromagnetic wave may be changed by the polarizer device) and the second polarization (to which the polarization of the second electromagnetic wave may be changed by the polarizer device) are each known, i.e. predefined. Thus, the first polarization and second polarization may be referred to as “first known polarization” and “second known polarization”, respectively. The polarizer device may be or may comprise a polarizer filter. The polarizer device may be configured to operate on or transform the electromagnetic wave impinging on the polarizer device, thus, transmitting or scattering an electromagnetic wave with a known polarization (i.e. the first or second polarization). The polarizer device may be controllable (e.g. by the controller) with regard to which of the first polarization and second polarization the polarization of an electromagnetic wave is changed to. The first polarization and second polarization may be different from each other. Alternatively, the first polarization optionally equals the second polarization. The first polarization may be opposite to the second polarization. The term “polarity” may optionally be used for referring to the term “polarization”

Since the device is configured to wirelessly emit electromagnetic waves, it may be referred to as “wireless device”. For example, the electromagnetic waves may be radio-frequency (electromagnetic) waves. The device may be referred to as transmitter device or wireless transmitter device. The device may be a radio-frequency (RF) transmitter device. In other words, the device may be configured to emit radio-frequency (electromagnetic) waves. The device may comprise one or more antennas for emitting electromagnetic waves. The emission of the electromagnetic waves by the device may be controlled via current or voltage signals in the device.

In case the device has no direct knowledge of its antenna polarization and/or orientation in space, the system allows the device to obtain a known reference polarization that may be defined by the polarizer device. The terms “radiate” and “emit” may be understood as synonyms and, thus, the passage “radiate an electromagnetic wave” may be used as a synonym for the passage “emit an electromagnetic wave”. For example, the device may be a communication device, e.g. a RF communication device configured to wirelessly communicate using RF (electromagnetic) waves, or a sensing device. For example, the second device may be a communication device, e.g. a RF communication device configured to wirelessly communicate using RF (electromagnetic) waves, or a sensing device. The device and optionally the second device may have limited means or no means to acquire knowledge of self-orientation in space and/or its antenna polarization. The device and optionally the second device may be off the shelf devices. The system may comprise the second device.

Optionally, the second electromagnetic wave may be opposite to the first electromagnetic wave up to a certain synchronization in time. That is, one or more symbols transmitted in the form of the second electromagnetic wave may be opposite to one or more symbols transmitted in the form of the first electromagnetic wave. In other words, the transmitted symbols may be arranged so that to generate first and second electromagnetic waves that are opposite with respect to a predefined timing reference or to induce at the receiver only opposite signals (i.e. without imposing to the transmitter necessarily to emit two opposite signals) corresponding to the first and second electromagnetic waves. Optionally the second electromagnetic wave may correspond (e.g. be the same or identical) to the first electromagnetic wave.

The environment may be the environment between the device and the second device. The controller may be any control means known in the art. The controller may be understood as being a control circuitry. The controller may comprise analogue circuitry or digital circuitry, or both analogue and digital circuitry. The digital circuitry may comprise components such as at least one of the one or more application-specific integrated circuits (ASICs), one or more field-programmable arrays (FPGAs), one or more digital signal processors (DSPs), one or more multi-purpose processors etc. The one or more processors may be any processing means known in the art. At least one of the one or more processors, optionally the one or more processors, may be understood as being one or more processing circuitries. At least one of the one or more processors, optionally the one or more processors, may comprise analogue circuitry or digital circuitry, or both analogue and digital circuitry. The digital circuitry may comprise components such as at least one of one or more application-specific integrated circuits (ASICs), one or more field-programmable arrays (FPGAs), one or more digital signal processors (DSPs), one or more multi-purpose processors etc. The controller and at least one of the one or more processors, optionally the one or more processors, may be the same type of apparatus. That is, they may be named differently merely for highlighting a main function of the respective apparatus. Optionally, the controller and at least one of the one or more processors, optionally the one or more processors, may be the same apparatus or may be part of a common control and processing apparatus.

In an implementation form of the first aspect, the controller is configured to provide first configuration information and/or second configuration information to the polarizer device. The polarizer device may be configured to, in response to obtaining the first configuration information, change the polarization of an electromagnetic wave impinged on the polarizer device to the first polarization. In addition or alternatively, the polarizer device may be configured to, in response to obtaining the second configuration information, change the polarization of an electromagnetic wave impinged on the polarizer device to the second polarization.

In other words, the polarizer device may be configured to be controlled by the first configuration information and second configuration information with regard to whether the polarization of the impinged electromagnetic wave is changed to the first polarization or the second polarization. The first configuration information and the second configuration information may be provided to the polarizer device wirelessly, wired and/or by any other means of configuration. For example, the first configuration information and the second configuration information may be provided in form of a first configuration message and second configuration message, respectively. The first configuration message and second configuration message may be provided to the polarizer device via a different channel compared to a channel via which the electromagnetic waves are provided to the polarizer device for impinging on the polarizer device. The first configuration information may comprise or be a first configuration order or command setting the polarizer device such that the polarization of an impinging electromagnetic wave is changed, by the polarizer device, to the first polarization. Accordingly, the second configuration information may comprise or be a second configuration order or command setting the polarizer device such that the polarization of an impinging electromagnetic wave is changed, by the polarizer device, to the second polarization.

Optionally, the controller is configured to provide configuration information to the polarizer device. The polarizer device may be configured to, in response to obtaining the configuration information, at first change the polarization of an electromagnetic wave impinged on the polarizer device to the first polarization and then change the polarization of an electromagnetic wave impinged on the polarizer device to the second polarization. That is, in response to obtaining the configuration information, the polarizer device may be configured to change, during a first time period, the polarization of an electromagnetic wave impinged on the polarizer device to the first polarization; and to change, during a second time period, the polarization of an electromagnetic wave impinged on the polarizer device to the second polarization. The second time period may be successive or directly successive (i.e. consecutive) to the first time period.

In an implementation form of the first aspect, the controller is configured to control the polarizer device to change, in a first time slot, the polarization of an electromagnetic wave impinged on the polarizer device to the first polarization. The controller may be configured to control the polarizer device to change, in a second time slot successive to the first time slot, the polarization of an electromagnetic wave impinged on the polarizer device to the second polarization.

In other words, the polarizer device may be configured to be controlled by a time control (i.e. dependent on time) with regard to whether the polarization of the impinged electromagnetic wave is changed to the first polarization or the second polarization. The term “successive” may mean “directly successive” (i.e. consecutive) so that the first time slot and second time slot are contiguous, or may mean “successive with at least one further time slot between the first time slot and the second time slot”. The term “after” may be used as a synonym for the term “successive”. The first time slot and the second time slot may be set such that the channel between the device, the second device and the polarizer device is constant. The first time slot and the second time slot may be within the same coherence time. Optionally, the first time slot may be triggered by a control message that may be obtained by the controller.

In an implementation form of the first aspect, the device is configured to wirelessly emit one or more first symbols for generating the first electromagnetic wave, and one or more second symbols for generating the second electromagnetic wave.

The one or more first symbols may form or be part of a first signal object, such as a first sub-frame of a frame or a first frame of a signal. The one or more second symbols may form or be part of a second signal object, such as a second sub-frame of the frame or a second frame of the signal. In other words, the device may be configured to emit a signal or frame in the form of the first electromagnetic wave and a second signal or second frame in the form of the second electromagnetic wave.

In an implementation form of the first aspect, the controller is configured to provide a first control message and/or a second control message to the device. The device may be configured to, in response to receiving the first control message, emit the first electromagnetic wave. The device may be configured to, in response to receiving the second control message, emit the second electromagnetic wave. The first control message and the second control message may be provided to the device wirelessly, wired and/or by any other means of configuration.

Optionally, the controller is configured to provide a control message to the device. The device may be configured to, in response to receiving the control message, at first emit the first electromagnetic wave, and then emit the second electromagnetic wave. There may be a time period between emission of the first electromagnetic wave and emission of the second electromagnetic wave. The control message may be provided to the device wirelessly, wired and/or by any other means of configuration.

In an implementation form of the first aspect, the controller is configured to control the device to wirelessly emit, in a first time slot, the first electromagnetic wave. The controller may be configured to control the device to wirelessly emit, in a second time slot successive to the first time slot, the second electromagnetic wave.

The first time slot and the second time slot may be set such that the channel between the device, the second device and the polarizer device is constant. The first time slot and the second time slot may be within the same coherence time. Optionally, the first time slot may be triggered by a control message that may be obtained by the controller.

In an implementation form of the first aspect, the one or more processors are configured to obtain, from the second device, a third electromagnetic wave resulting from the propagation of the electromagnetic wave with the first polarization and a fourth electromagnetic wave resulting from the propagation of the electromagnetic wave with the second polarization. The one or more processors may be configured to compute the reference polarization by processing the third electromagnetic wave and the fourth electromagnetic wave.

In an implementation form of the first aspect, the one or more processors are configured to compute the reference polarization by at least one of processing, and combining, and applying a function to, the third electromagnetic wave or any symbol resulting from receiving the third electromagnetic wave, and to the fourth electromagnetic wave or any symbol resulting from receiving the fourth electromagnetic wave.

In an implementation form of the first aspect, the system comprises the second device, and at least one of the processors configured to compute the reference polarization is included in the second device.

In an implementation form of the first aspect, the one or more processors are configured to obtain, from the second device, one or more third symbols resulting from receiving the electromagnetic wave with the first polarization and one or more fourth symbols resulting from receiving the electromagnetic wave with the second polarization. The one or more processors may be configured to perform the channel estimation of the environment and/or sense the environment by processing the one or more third symbols and the one or more fourth symbols. In other words, the one or more processors may be configured to do the following by processing the one or more third symbols and the one or more fourth symbols: perform the channel estimation of the environment and/or sense the environment.

Since the second device is configured to wirelessly receive electromagnetic waves, it may be referred to as “second wireless device”. For example, the electromagnetic waves may be radio-frequency (electromagnetic) waves. The second device may be referred to as receiver device or wireless receiver device. The device may be a radio-frequency (RF) receiver device. In other words, the device may be configured to receive radio-frequency (electromagnetic) waves. The second device may comprise one or more antennas for receiving electromagnetic waves. The second device may be configured to receive, in a first time slot, the electromagnetic wave with the first polarization, and receive, in a second time slot successive to the first time slot, the electromagnetic wave with the second polarization.

For example, the second device may comprise one or more antennas configured to receive the third electromagnetic wave and the fourth electromagnetic wave and transform the third electromagnetic wave and the fourth electromagnetic wave into the one or more third symbols and the one or more fourth symbols, respectively. In other words, the one or more antennas may be configured to receive the third electromagnetic wave and the fourth electromagnetic wave and transform the third electromagnetic wave and the fourth electromagnetic wave into a first signal (e.g. first current or first voltage) and a second signal (e.g. second current or second voltage), respectively.

In an implementation form of the first aspect, the one or more processors are configured to perform the channel estimation of the environment and/or sense the environment by performing one or more linear combinations of the one or more fourth symbols and the one or more third symbols. In other words, the one or more processors may be configured to do the following by performing one or more linear combinations of the one or more fourth symbols and the one or more third symbols: perform the channel estimation of the environment and/or sense the environment. In addition or alternatively, the one or more processors may be configured to perform the channel estimation of the environment and/or sense the environment by performing one or more linear combinations of the third electromagnetic wave and the fourth electromagnetic wave. In other words, the one or more processors may be configured to do the following by performing one or more linear combinations of the third electromagnetic wave and the fourth electromagnetic wave: perform the channel estimation of the environment and/or sense the environment.

For example, the one or more processors are configured to perform the channel estimation of the environment and/or sense the environment by subtracting the one or more fourth symbols from the one or more third symbols. Optionally, the one or more processors are configured to perform the channel estimation of the environment and/or sense the environment by subtracting the fourth electromagnetic wave from the third electromagnetic wave. The optional feature(s) of performing the channel estimation of the environment and/or sensing the environment by performing one or more linear combinations of the third electromagnetic wave and the fourth electromagnetic wave may be present on its own or in combination with the optional feature of computing the reference polarization by processing the third electromagnetic wave and the fourth electromagnetic wave. In other words, the one or more processors may be configured to compute the reference polarization by processing the third electromagnetic wave and the fourth electromagnetic wave. In addition or alternatively, the one or more processors may be configured to perform the channel estimation of the environment by performing one or more linear combinations of the third electromagnetic wave and the fourth electromagnetic wave. In addition or alternatively, the one or more processors may be configured to sense the environment by performing one or more linear combinations of the third electromagnetic wave and the fourth electromagnetic wave.

In an implementation form of the first aspect, at least one of the processors configured to perform the channel estimation and/or sense the environment is included in the device.

In an implementation form of the first aspect, the second device is configured to provide the one or more third symbols or the third electromagnetic wave and the one or more fourth symbols or the fourth electromagnetic wave to the one or more processors. That is, the second device may be configured to provide the one or more third symbols and the one or more fourth symbols to the one or more processors. The second device may be configured to provide the third electromagnetic wave and the fourth electromagnetic wave to the one or more processors.

In an implementation form of the first aspect, the one or more processors are configured to perform an object sensing of an object based on the first electromagnetic wave and the second electromagnetic wave.

In an implementation form of the first aspect, at least one of the processors configured to perform the object sensing is included in the polarizer device.

In order to achieve the system according to the first aspect of the disclosure, some or all of the implementation forms and optional features of the first aspect, as described above, may be combined with each other.

A second aspect of this disclosure provides a method for at least one of determining a reference polarization, performing channel estimation of an environment and sensing the environment, wherein the method comprises wirelessly emitting, by a device, a first electromagnetic wave such that the first electromagnetic wave impinges on a polarizer device and on a second device. The method comprises changing, by the polarizer device, a polarization of the first electromagnetic wave impinged on the polarizer device to a first polarization, and transferring the first electromagnetic wave with the first polarization such that the first electromagnetic wave with the first polarization impinges on the second device. The method comprises wirelessly emitting, by the device, a second electromagnetic wave, such that the second electromagnetic wave impinges on the polarizer device and on the second device. The method comprises changing, by the polarizer device, a polarization of the second electromagnetic wave impinged on the polarizer device to a second polarization, and transferring the second electromagnetic wave with the second polarization such that the second electromagnetic wave with the second polarization impinges on the second device.

The method may comprise determining the reference polarization, performing the channel estimation and/or sensing the environment based on the first electromagnetic wave with the first polarization and the second electromagnetic wave with the second polarization.

The steps of the method with regard to emitting the first electromagnetic wave and changing the polarization of the first electromagnetic wave may be performed in a first time slot. The steps of the method with regard to emitting the second electromagnetic wave and changing the polarization of the second electromagnetic wave may be performed in a second time slot successive to the first time slot.

The steps of the method with regard to emitting the first electromagnetic wave and changing the polarization of the first electromagnetic wave may be triggered by a first control message and first configuration information, respectively, sent to the device and the polarizer device, respectively. The steps of the method with regard to emitting the second electromagnetic wave and changing the polarization of the second electromagnetic wave may be triggered by a second control message and second configuration information, respectively, sent to the device and the polarizer device, respectively.

Optionally, the steps of the method with regard to emitting the first electromagnetic wave and emitting the second electromagnetic wave may be triggered by a control message sent to the device. The steps of the method with regard to changing the polarization of the first electromagnetic wave and changing the polarization of the second electromagnetic wave may be triggered by a configuration information sent to the polarizer device. Optionally, the steps of the method with regard to emitting the first electromagnetic wave, changing the polarization of the first electromagnetic wave, emitting the second electromagnetic wave and changing the polarization of the second electromagnetic wave may be triggered by a message sent to the device and the polarizer device.

For example, the second electromagnetic wave may be opposite to the first electromagnetic wave up to a certain synchronization in time. That is, one or more symbols transmitted in the form of the second electromagnetic wave may be opposite to one or more symbols transmitted in the form of the first electromagnetic wave. In other words, the transmitted symbols may be arranged so that to generate first and second electromagnetic waves that are opposite with respect to a predefined timing reference or to induce at the receiver only opposite signals (i.e. without imposing to the transmitter necessarily to emit two opposite signals) corresponding to the first and second electromagnetic waves.

The description of the system according to the first aspect is correspondingly valid for the method of the second aspect. The description of the method according to the second aspect may be correspondingly valid for the system according to the first aspect.

The method of the second aspect and its implementation forms and optional features achieve the same advantages as the system of the first aspect and its respective implementation forms and respective optional features.

In an implementation form of the second aspect, the method comprises providing first configuration information and/or second configuration information to the polarizer device. The method may comprise, in response to obtaining the first configuration information, changing, by the polarizer device, the polarization of an electromagnetic wave impinged on the polarizer device to the first polarization. In addition or alternatively, the method may comprise, in response to obtaining the second configuration information, changing, by the polarizer device, the polarization of an electromagnetic wave impinged on the polarizer device to the second polarization.

Optionally, the method comprises providing a configuration information to the polarizer device. The method may comprise, in response to obtaining the configuration information, changing, by the polarizer device, at first the polarization of an electromagnetic wave impinged on the polarizer device to the first polarization, and then changing, by the polarizer device, the polarization of an electromagnetic wave impinged on the polarizer device to the second polarization. That is, in response to obtaining the configuration information, the polarizer device may change, during a first time period, the polarization of an electromagnetic wave impinged on the polarizer device to the first polarization; and change, during a second time period, the polarization of an electromagnetic wave impinged on the polarizer device to the second polarization. The second time period may be successive or directly successive (i.e. consecutive) to the first time period.

In an implementation form of the second aspect, the method comprises controlling the polarizer device to change, in a first time slot, the polarization of an electromagnetic wave impinged on the polarizer device to the first polarization. The method may comprise controlling the polarizer device to change, in a second time slot successive to the first time slot, the polarization of an electromagnetic wave impinged on the polarizer device to the second polarization.

In an implementation form of the second aspect, the method comprises wirelessly emitting, by the device, one or more first symbols for generating the first electromagnetic wave, and one or more second symbols for generating the second electromagnetic wave.

In an implementation form of the second aspect, the method comprises providing a first control message and/or a second control message to the device. The method may comprise, in response to receiving the first control message, emitting, by the device, the first electromagnetic wave. The method may comprise, in response to receiving the second control message, emitting, by the device, the second electromagnetic wave.

In an implementation form of the second aspect, the method comprises controlling the device to wirelessly emit, in a first time slot, the first electromagnetic wave. The method may comprise controlling the device to wirelessly emit, in a second time slot successive to the first time slot, the second electromagnetic wave.

In an implementation form of the second aspect, the method comprises obtaining, from the second device, a third electromagnetic wave resulting from the propagation of the electromagnetic wave with the first polarization and a fourth electromagnetic wave resulting from the propagation of the electromagnetic wave with the second polarization. The method may comprise computing the reference polarization by processing the third electromagnetic wave and the fourth electromagnetic wave.

In an implementation form of the second aspect, the method comprises computing the reference polarization by at least one of processing, and combining, and applying a function to, the third electromagnetic wave or any symbol resulting from receiving the third electromagnetic wave, and to the fourth electromagnetic wave or any symbol resulting from receiving the fourth electromagnetic wave.

In an implementation form of the second aspect, computing the reference polarization is performed by the second device.

In an implementation form of the second aspect, the method comprises obtaining, from the second device, one or more third symbols resulting from receiving the electromagnetic wave with the first polarization and one or more fourth symbols resulting from receiving the electromagnetic wave with the second polarization. The method may comprise performing the channel estimation of the environment and/or sensing the environment by processing the one or more third symbols and the one or more fourth symbols.

In an implementation form of the second aspect, the method comprises performing the channel estimation of the environment and/or sensing the environment by performing one or more linear combinations of the one or more fourth symbols and the one or more third symbols. In addition or alternatively, the method may comprise performing the channel estimation of the environment and/or sensing the environment by performing one or more linear combinations of the third electromagnetic wave and the fourth electromagnetic wave.

In an implementation form of the second aspect, performing the channel estimation and/or sensing the environment is performed by the device.

In an implementation form of the second aspect, the method comprises providing, by the second device, the one or more third symbols or the third electromagnetic wave and the one or more fourth symbols or the fourth electromagnetic wave.

In an implementation form of the second aspect, the method comprises performing an object sensing of an object based on the first electromagnetic wave and the second electromagnetic wave.

In an implementation form of the second aspect, the method comprises performing, by the polarizer device, the object sensing.

In order to achieve the method according to the second aspect of the disclosure, some or all of the implementation forms and optional features of the second aspect, as described above, may be combined with each other.

All steps which are performed by the various entities described in the present application as well as the functionalities described to be performed by the various entities are intended to mean that the respective entity is adapted to or configured to perform the respective steps and functionalities. Even if, in the following description of specific embodiments, a specific functionality or step to be performed by external entities is not reflected in the description of a specific detailed element of that entity which performs that specific step or functionality, it should be clear for a skilled person that these methods and functionalities can be implemented in respective software or hardware elements, or any kind of combination thereof.

### BRIEF DESCRIPTION OF DRAWINGS

The above described aspects and implementation forms will be explained in the following description of specific embodiments in relation to the enclosed drawings, in which

FIG. 1 shows an example of a system according to an embodiment of this disclosure.

FIG. 2 shows an example of a system according to an embodiment of this disclosure.

FIG. 3 shows an example of a method according to an embodiment of this disclosure.

FIG. 4 shows an example of a system according to an embodiment of this disclosure.

FIG. 5 shows an example of two states of the system of FIG. 4.

FIG. 6 shows an example of a method according to an embodiment of this disclosure.

In the Figures, corresponding elements may be labelled with the same reference sign.

### DETAILED DESCRIPTION OF EMBODIMENTS

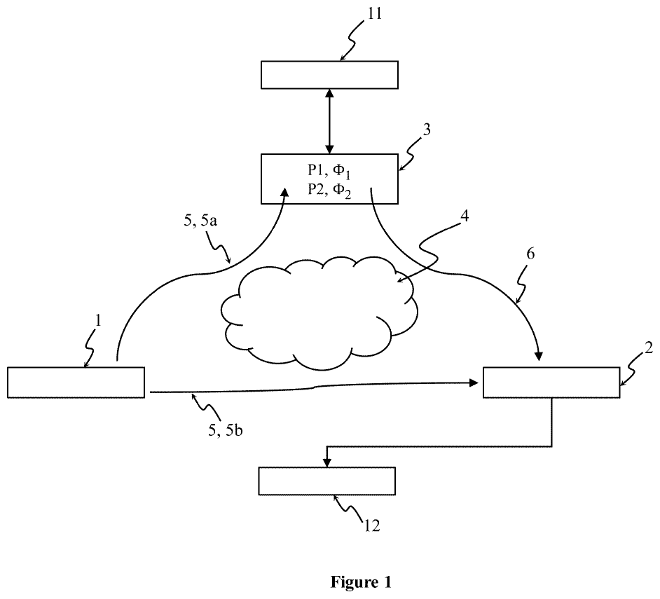

FIG. 1 shows an example of a system according to an embodiment of this disclosure. The system is an example of the system according to the first aspect of this disclosure. Thus, the description of the system according to the first aspect is correspondingly valid for the system of FIG. 1.

The system of FIG. 1 is a system for at least one of determining a reference polarization, performing channel estimation of an environment and sensing the environment. The system comprises a controller 11, one or more processors 12, a polarizer device 3, and a device 1. The device 1 is configured to wirelessly emit a first electromagnetic wave 5 such that the first electromagnetic wave 5 impinges on the polarizer device 3 and on a second device 2, and a second electromagnetic wave 5 such that the second electromagnetic wave 5 impinges on the polarizer device 3 and on the second device 2. The device 1 may be referred to as “first device”. In FIG. 1, the part of a respective electromagnetic wave 5 impinging on the polarizer device 3 is labelled with the reference sign “5a” and the part of the respective electromagnetic wave 5 directly impinging on the second device 2 is labelled with the reference sign “5b”. The controller 11 is configured to control the polarizer device 3 to change a polarization of the first electromagnetic wave 5a impinged on the polarizer device 3 to a first polarization P1, such that the first electromagnetic wave 6 with the first polarization P1 impinges on the second device 2. In FIG. 1, an electromagnetic wave impinging on the second device 2 that is obtained from the polarizer device 3 is labelled by the reference sign “6”. The controller 11 is configured to control the polarizer device 3 to change a polarization of the second electromagnetic wave 5a impinged on the polarizer device 3 to a second polarization P2, such that the second electromagnetic wave 6 with the second polarization P2 impinges on the second device 2. In FIG. 1, the configuration of the polarizer device for achieving the first polarization P1 is indicated by Φ₁ and the configuration of the polarizer device for achieving the second polarization P2 is indicated by Φ₂. For example, the effect of the polarizer device 3 on an impinging electromagnetic wave for transforming the polarization of the impinging electromagnetic wave to the first polarization P1 may be represented by a matrix multiplication operation using a matrix Φ₁ (e.g. projection matrix) applied to the impinging electromagnetic wave. Accordingly, the effect of the polarizer device 3 on an impinging electromagnetic wave for transforming the polarization of the impinging electromagnetic wave to the second polarization P2 may be represented by a matrix multiplication operation using a matrix Φ₂ (e.g. projection matrix) applied to the impinging electromagnetic wave. The one or more processors 12 are configured to determine the reference polarization, perform the channel estimation and/or sense the environment based on the first electromagnetic wave 6 with the first polarization P1 and the second electromagnetic wave 6 with the second polarization P2. For this the one or more processors 12 may obtain the first electromagnetic wave 6 with the first polarization P1 and the second electromagnetic wave 6 with the second polarization P2 from the second device 2, as indicated in FIG. 1.

Thus, as exemplarily shown in FIG. 1, an environment 4 (e.g. a scene of interest) may be illuminated, by the device 1, with an electromagnetic wave 5 having an unknown polarization such that the electromagnetic wave (travelling through the environment 4) impinges on the polarizer device 3 and the second device 2. The polarizer device 3 may operate on the impinging electromagnetic wave and transmit or scatter an electromagnetic wave (resulting from the impinging wave) with a known polarization (e.g. the first polarization P1 or the second polarization P2) regardless of the polarization of the impinging wave.

The device 1, the second device 2, the polarizer device 3, the controller 11 and the one or more processors 12 may be implemented as already described with regard to the system of the first aspect of this disclosure.

The device 1 may comprise a processor or processing circuitry (not shown) configured to perform, conduct or initiate the various operations of the device 1 described herein. The processing circuitry may comprise hardware and/or the processing circuitry may be controlled by software. The hardware may comprise analogue circuitry or digital circuitry, or both analogue and digital circuitry. The digital circuitry may comprise components such as at least one of one or more application-specific integrated circuits (ASICs), one or more field-programmable arrays (FPGAs), one or more digital signal processors (DSPs), and one or more multi-purpose processors. The device 1 may further comprise memory circuitry, which stores one or more instruction(s) that can be executed by the processor or by the processing circuitry, in particular under control of the software. For instance, the memory circuitry may comprise a non-transitory storage medium storing executable software code which, when executed by the processor or the processing circuitry, causes the various operations of the device 1 to be performed. In one embodiment, the processing circuitry comprises one or more processors and a non-transitory memory connected to the one or more processors. The non-transitory memory may carry executable program code which, when executed by the one or more processors, causes the device 1 to perform, conduct or initiate the operations or methods described herein.

The second device 2 may comprise a processor or processing circuitry (not shown) configured to perform, conduct or initiate the various operations of the second device 2 described herein. The processing circuitry may comprise hardware and/or the processing circuitry may be controlled by software. The hardware may comprise analogue circuitry or digital circuitry, or both analogue and digital circuitry. The digital circuitry may comprise components such as at least one of one or more application-specific integrated circuits (ASICs), one or more field-programmable arrays (FPGAs), one or more digital signal processors (DSPs), and one or more multi-purpose processors. The second device 2 may further comprise memory circuitry, which stores one or more instruction(s) that can be executed by the processor or by the processing circuitry, in particular under control of the software. For instance, the memory circuitry may comprise a non-transitory storage medium storing executable software code which, when executed by the processor or the processing circuitry, causes the various operations of the second device 2 to be performed. In one embodiment, the processing circuitry comprises one or more processors and a non-transitory memory connected to the one or more processors. The non-transitory memory may carry executable program code which, when executed by the one or more processors, causes the second device 2 to perform, conduct or initiate the operations or methods described herein.

Optionally, the second device 2 may be part of the system. The controller may be part of the device 1, the second device 2 or the polarizer device 3. At least one of the one or more processors 12, optionally the one or more processors 12, may be part of the device 1, the second device 2 or the polarizer device 3. The controller 11 and the polarizer device 3 may communicate with each other wirelessly, wired and/or by any other means of configuration. The one or more processors 12 and the second device 2 may communicate with each other wirelessly, wired and/or by any other means of configuration. For example, there may be a data and information transfer from the second device 2 to at least one of the one or more processors 12, optionally the one or more processors 12.

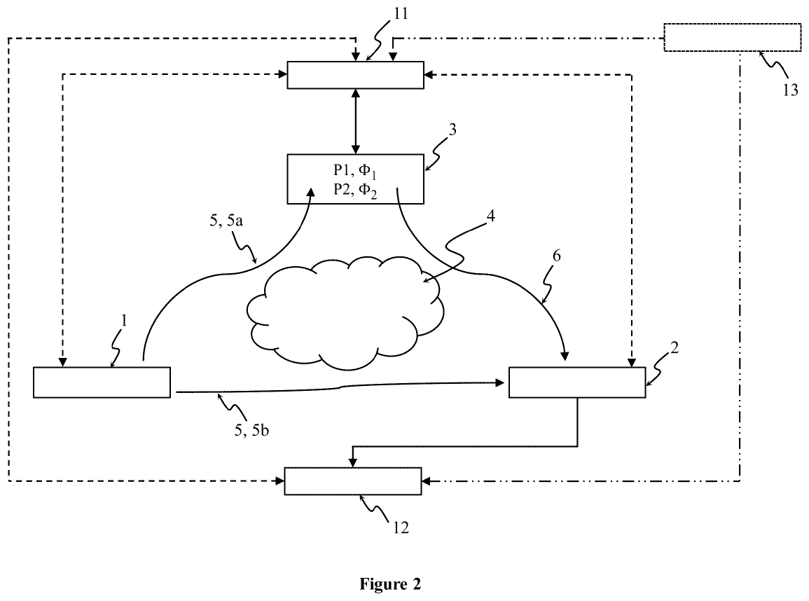

For further information, such as more details (e.g. in the form of additional optional features), on the system of FIG. 1 reference is made to the description of the system according to the first aspect of this disclosure and the description of FIGS. 2 to 6.

FIG. 2 shows an example of a system according to an embodiment of this disclosure. The system of FIG. 2 corresponds to the system of FIG. 1 comprising additional optional features. Thus, the description of the system of FIG. 1 is also valid for the system of FIG. 2 and in the following mainly the additional optional features of the system of FIG. 2 are described.

As shown in FIG. 2, the device 1 and the controller 11 may communicate with each other, wherein the communication may be wireless, wired and/or by any other means of configuration. The second device 2 and the controller 11 may communicate with each other, wherein the communication may be wireless, wired and/or by any other means of configuration. Thus, there may be a signaling and synchronization, by the controller 11, of the device 1, the second device 2 and the polarizer device 3.

The controller 11 and at least one of the one or more processors 12, optionally the one or more processors 12, may communicate with each other, wherein the communication may be wireless, wired and/or by any other means of configuration. The controller 11 may obtain an optional input 13. The input 13 may comprise information on expected outputs and optionally on adapted processing and/or configurations to achieve the expected outputs. The input 13 may be communicated to the controller 11, wherein the communication may be wireless, wired and/or by any other means of configuration. At least one of the one or more processors 12, optionally the one or more processors 12, may obtain optional inputs, such as the input 13. The input 13 may be communicated to at least one of the one or more processors 12, optionally to the one or more processors 12, wherein the communication may be wireless, wired and/or by any other means of configuration. The input 13 may comprise, with regard to at least one of reference polarization determination (may be referred to as reference polarization acquisition), channel estimation of the environment (e.g. propagation environment estimation) and sensing of the environment (e.g. object sensing), information on expected outputs and optionally on adapted processing and/or configurations to achieve the expected outputs. Optionally, the input 13 comprises, with regard to any combination of reference polarization determination (may be referred to as reference polarization acquisition), channel estimation of the environment (e.g. propagation environment estimation) and sensing of the environment (e.g. object sensing), information on expected outputs and optionally on adapted processing and/or configurations to achieve the expected outputs.

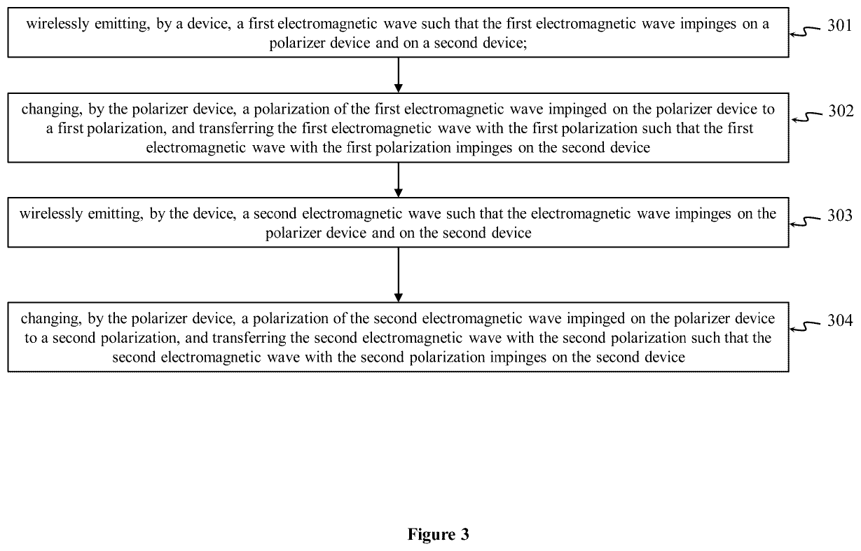

FIG. 3 shows an example of a method according to an embodiment of this disclosure. The method is an example of the method according to the second aspect of this disclosure. Thus, the description of the method according to the second aspect is correspondingly valid for the method of FIG. 3.

The method of FIG. 3 is a method for at least one of determining a reference polarization, performing channel estimation of an environment and sensing the environment. The method comprises wirelessly emitting, by a device, a first electromagnetic wave such that the first electromagnetic wave impinges on a polarizer device and on a second device. This step is labelled in FIG. 3 with the reference sign “301”. The method comprises changing, by the polarizer device, a polarization of the first electromagnetic wave impinged on the polarizer device to a first polarization, and transferring the first electromagnetic wave with the first polarization such that the first electromagnetic wave with the first polarization impinges on the second device. This step is labelled in FIG. 3 with the reference sign “302”. The method comprises wirelessly emitting, by the device, a second electromagnetic wave, such that the second electromagnetic wave impinges on the polarizer device and on the second device. This step is labelled in FIG. 3 with the reference sign “303”. The method comprises changing, by the polarizer device, a polarization of the second electromagnetic wave impinged on the polarizer device to a second polarization, and transferring the second electromagnetic wave with the second polarization such that the second electromagnetic wave with the second polarization impinges on the second device This step is labelled in FIG. 3 with the reference sign “304”. The method may comprise determining the reference polarization, performing the channel estimation and/or sensing the environment based on the first electromagnetic wave with the first polarization and the second electromagnetic wave with the second polarization (not shown in FIG. 3).

The device, second device and polarizer device may correspond to the device, second device and polarizer device of the system of FIG. 1, 2, 4 or 5. For further information, such as more details (e.g. in the form of additional optional features), on the method of FIG. 3 reference is made to the description of the method according to the second aspect of this disclosure and the description of FIGS. 1, 2 and 4 to 6.

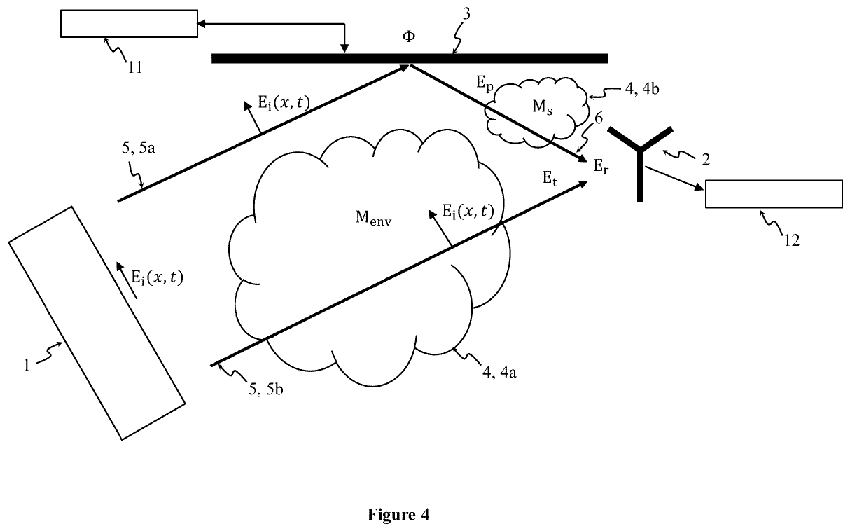

FIG. 4 shows an example of a system according to an embodiment of this disclosure. The system of FIG. 4 is an example of the system of FIG. 1. Thus, the description of the system of FIG. 1 is also valid for the system of FIG. 4. The description of the system of FIG. 2 may be valid for the system of FIG. 4.

It may be assumed that the device 1 is a communication device, such as a transmitter device (e.g. radio-frequency transmitter device), equipped with one or more antennas, wherein the electromagnetic waves emittable using the one or more antennas may be controlled through current or voltage signals in the transmitter device. The device 1 may be configured to transmit and receive, using the one or more antennas, electromagnetic waves, such as radio-frequency waves. It may be assumed that the second device 2 is a communication device, such as a receiver device (e.g. radio-frequency receiver device), equipped with one or more antennas, wherein the electromagnetic waves receivable using the one or more antennas may be transformed in current or voltage signals in the receiver device. The second device 2 may be configured to transmit and receive, using the one or more antennas, electromagnetic waves, such as radio-frequency waves. The aforementioned assumption are only by way of example and do not limit this disclosure. Thus, the following description is correspondingly valid in case the device 1 and second device 2 are a different type of device configured to wirelessly transmit and/or receive using electromagnetic waves. In FIG. 4, electromagnetic waves are represented by electric fields. This is only by way of example and does not limit this disclosure. The transmitted wave is represented by Eᵢ (x,t) which is the electric field generated by the device 1 and observed in location x and at time t.

In FIG. 4, the second device 2 may be referred to as the device of interest (e.g. observing device or sensing device). At the second device 2, an impinging electric field Er (caused by the device 1 emitting an electromagnetic wave towards a scene of interest 4b) is received through two paths, one path (e.g. the one of interest for reference polarization retrieval) of the two paths is via the polarizer device 3 and the scene of interest 4b, i.e. the received electric field Er has been reflected by the polarizer device 3 and scattered by the scene of interest 4b. The reflection by the polarizer device 3 may be represented by a matrix multiplication of the electric filed Eᵢ impinging on the polarizer device 3 with a matrix Φ defining the polarization configuration of the polarizer device 3. The scattering by the scene of interest 4b may be represented by a multiplication of the electric field Ep having a polarization according to the polarization configuration of the polarizer device 3 with a matrix Ms. That is, the effect of the scattering by the scene of interest may be represented by the matrix Ms. Another path of the aforementioned two paths crosses the ambient environment 4a, wherein the received electric field Er has been scattered by the ambient environment 4a. That is, the ambient environment 4a may provide undesired scattering to electromagnetic waves transmitted through the environment 4a. The scattering by the ambient environment 4a may be represented by a multiplication of the electric field Eᵢ (e.g. of unknown polarization) with a matrix Meny. That is, the effect of the scattering by the ambient environment 4a may be represented by the matrix Meny. Regardless of the way with which the second device 2 observes the resulting electromagnetic wave impinging on the second device 2, the corresponding electric field Er may be written as the combination of both paths, and writes as:

$${E}_{r} = {M}_{s} Φ {E}_{i} + {M}_{e n v} {E}_{i}$$

In above formula the term “E;” represents an electric field of the emitted electromagnetic waves and illuminating the scene of interest 4b through the polarizer device 3 and environment 4a. The incident electromagnetic waves may be transmitted by the device 1 for illuminating the environment 4.

Optionally, the second device 2 (e.g. sensing device) may be equipped with at least one antenna that converts the impinging field Er into an electric signal perceived as current or voltage. Depending on the antenna structure, this conversion may be a linear transformation that converts the electric field Er into a one dimensional, two dimensional, or three dimensional signal in time or frequency representation.

The device 1, second device 2 and the polarizer device 3 may be configured to work according to a protocol that may enable polarimetry based applications, such as reference polarization determination (may be referred to as reference polarization acquisition), channel estimation of the environment (e.g. propagation environment estimation), and/or sensing of the environment (e.g. object sensing), for non-calibrated devices operating in non-controlled environments. That is, the polarization of the incident waves illuminating the scene of interest 4b through the polarizer device 3 (represented by the electric field Eᵢ) and illuminating the ambient environment 4a (represented by the electric filed Eᵢ) may be unknown, and may be not under control. The received wave at the second device 2 (represented by the electric field Er) may be with one or multiple waves which crossed a non-controlled environment 4 and are the result of scattering on obstacles. The second device 2 that may obtain (e.g. measure) the received or perceived field Er (e.g. the scattered field Er) may be not calibrated. That is, the second device 2 may be not aware about its orientation and measures the electric field Er with respect to an unknown coordinate system.

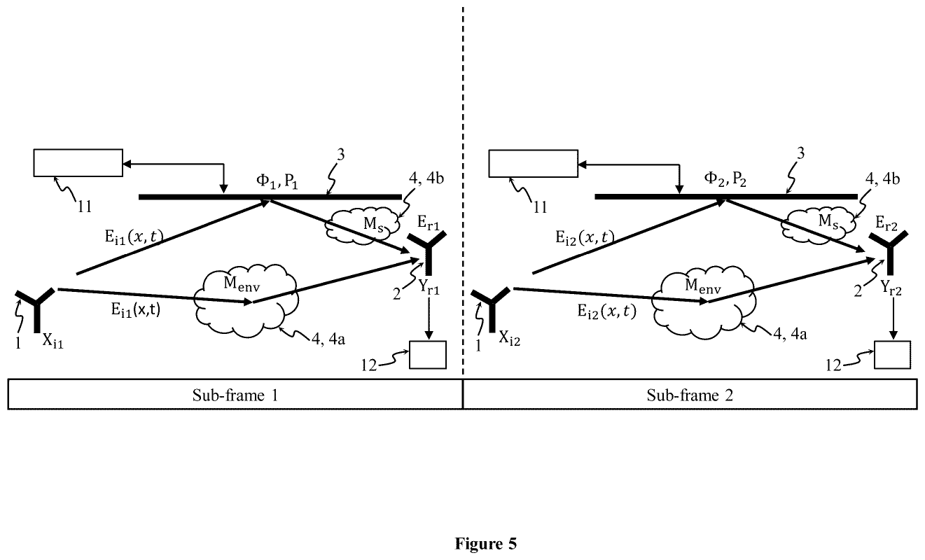

FIG. 5 shows an example of two states of the system of FIG. 4. FIG. 5 may show an example of two states of the system of FIG. 4 according to the described transmission protocol for reference polarization determination. The first state corresponds to a first time period (may be referred to as first time slot) and the second state corresponds to a second time period (may be referred to as second time slot) following the first time period. Optionally, during the first time period the device 1 may transmit a first sub-frame “Subframe 1” to the second device 2 by emitting electromagnetic waves such that the electromagnetic waves travel via a first path comprising the polarizer device 3 and the scene of interest 4b and a second path comprising the ambient environment 4a. Optionally, during the second time period the device 1 may transmit a second sub-frame “Sub-frame 2” to the second device 2 by emitting electromagnetic waves such that the electromagnetic waves travel via the first path comprising the polarizer device 3 and the scene of interest 4b and a second path comprising the ambient environment 4a.

In the following an example of determining a reference polarization for the device 1 and the second device 2 using the polarizer device 3 is described. For this a phase and time synchronization with respect to the electromagnetic waves impinging on the polarizer device 3 may be assumed. For example, a sub-frame synchronization between the various entities, i.e. a synchronization of their respective configurations over a given sub-frame, may be assumed. In a first time period, the polarizer device 3 may be in a first setting (configuration) and its action may be modelled with the matrix Φ₁ while being illuminated by the device 1 in the first time period with an electric field that writes as Eᵢ₁ (x, t). The rest of the scene is illuminated with a wave whose electric field writes as Eᵢ₁ (x, t). Thus, the second device 2 (may be referred to as device of interest) may observe in the first time period an electric field Eᵣ₁(t) that may be written as:

$${E}_{r 1} ( t ) = {\int }_{x ∈ ℰ} {M}_{e n v} ( x ) {E}_{i 1} ( x , t - {δ}_{1} ( x ) ) d x + {\int }_{x ∈ 𝒫} {M}_{s} {Φ}_{1} {E}_{i 1} ( x , t - {δ}_{0} ( x ) ) d x$$

where [symbol] is the surface of the polarizer device 3, and E is the volume/surface of the ambient environment 4a contributing to the scattered waves that reaches the second device 2 (e.g. sensing device). In a second time period following the first time period, the polarizer device 3 may be in a second setting (configuration) and its action may be modelled with a matrix Φ₂, while being illuminated with an electric field that writes for example as Eᵢ₂=−Eⱼ₁ with respect to a predefined time reference. Thus, the second device 2 (may be referred to as device of interest) may observe in the second time period an electric field Eᵣ₂(t) which can be written as:

$${E}_{r 2} ( t ) = {\int }_{x ∈ ℰ} - {M}_{e n v} ( x ) {E}_{i 1} ( x , t - {δ}_{1} ( x ) ) d x - {\int }_{x ∈ 𝒫} {M}_{s} {Φ}_{2} {E}_{i 1} ( x , t - {δ}_{0} ( x ) ) d x$$

The second device 2 may build or make a new observation by summing the observations of the first time period and the second time period, which may be represented by the following formula:

$${E}_{r 2} ( t ) + {E}_{r 1} ( t ) = {\int }_{x ∈ 𝒫} {M}_{s} ( {Φ}_{1} - {Φ}_{2} ) {E}_{i 1} ( x , t - {δ}_{0} ( x ) ) d x$$

The polarizer device setting Φ₁ of the first time period and the polarizer device setting Φ₂ of the second time period may be chosen such that the difference between them, i.e. Φ₁-Φ₂, is a rank one matrix given by E_{ref}A^{T} which makes (Φ₁-Φ₂) Eⱼ₁ (x, t) colinear with the vector E_{ref} regardless of the incident field Eᵢ₁ and optionally provided that A^{T}Eᵢ₁≠0 is fulfilled. The rank one matrix is represented by “A^{T}”. The new observation obtained by the second device 2, emulates an illumination of the environment Mₛ with a wave containing known polarization E_{ref} (e.g. pure and known polarization). Thus, as shown above, the system may compute the reference polarization.

The processing of the electric field Eᵣ₁(t) observed by the second device 2 in the first time period and the electric field Eᵣ₂(t) observed by the second device 2 in the second time period may be performed by the one or more processors 12. For this, the one or more processors 12 may obtain, from the second device 2, a third electromagnetic wave (represented by the electric field Eᵣ₁) resulting from the propagation of a first electromagnetic wave with the first polarization P1 and a fourth electromagnetic wave (represented by the electric field Eᵣ₂) resulting from the propagation of a second electromagnetic wave with the second polarization P2. The one or more processors may compute the reference polarization by processing the third electromagnetic wave (represented by the electric wave Eᵣ₁) and the fourth electromagnetic wave (represented by the electric wave Eᵣ₂). In the above described example it is assumed that the device 1 is configured to wirelessly emit the second electromagnetic wave such that the second electromagnetic wave is opposite to the first electromagnetic wave up to a certain synchronization in time i.e. Eᵢ₂=−Eᵢ₁. This is only by way of example and does not limit the present disclosure.

As outlined above, the one or more processors 12 may be configured to compute the reference polarization by at least one of processing, and combining, and applying a function to, the third electromagnetic wave (represented by the electric field Eᵣ₁) or any symbol resulting from receiving the third electromagnetic wave, and to the fourth electromagnetic wave (represented by the electric field Eᵣ₂) or any symbol resulting from receiving the fourth electromagnetic wave. In the above example described with regard to FIG. 5, the one or more processors 12 may compute the reference polarization by adding the third electromagnetic wave represented by the electric field Eri and the fourth electromagnetic wave represented by the electric field Eᵣ₂ (i.e. Eᵣ₂(t)+Eᵣ₁(t)).

According to another example, it may be assumed that the device 1 is a wireless communication device (e.g. transmitter device), i.e. the incident waves Eᵢ₁ and Eᵢ₂ are assumed to be generated with the help of a wireless communication device. For this case, the incident fields Eᵢ₁ (x, t) and Eᵢ₂ (x, t) may be written as a function of the transmitted signal Xᵢ(t) as follows:

$${E}_{i 1} ( t ) = {ℒ}_{1} ( {X}_{i 1} ( t ) ) , {E}_{i 2} ( t ) = {ℒ}_{2} ( {X}_{i 2} ( t ) ) ,$$

where [symbol] ₁( . . . ) and [symbol] ₂ ( . . . ) are linear operators modelling the transformation from signal (current or voltage) to electric field besides the propagation between the transmit antenna (of the device 1) and the polarizer device 3 and ambient environment 4 surrounding the second device 2 (device of interest).

Accordingly, determining a reference polarization for the device 1 and the second device 2 using the polarizer device 3 may be implemented by the transmitted frame signal Xᵢ₁ during the first time period while configuring the polarizer device 3 in the first setting (configuration) represented by Φ₁ and transmitting for example a frame signal Xᵢ₂=−Xᵢ₁ during the second time period following the first time period while configuring the polarizer device 3 in the second setting represented by Φ₂. For this, a prior time and phase synchronization between the device 1 and the second device 2 may be assumed.

Assuming that the second device 2 employs one or more antennas to measure the received field, the signal generated at the second device is given by Yᵣ₁(t)= [symbol] (Eᵣ₁(t)), and Yᵣ₂(t)= [symbol] (Eᵣ₂(t)) for the first time period phase and the second time period, respectively, where [symbol] (.) is a linear operator representing the transformation from electric field to an electric signal at the sensing device (current or voltage).

The second device 2 may build a new frame using the sum of Yᵣ₁ and Yᵣ₂ which writes as

$${Y}_{r 1} ( t ) + {Y}_{r 2} ( t ) ∝ ℛ ( {M}_{s} {E}_{ref} )$$

The new frame emulates the signal that would be received when illuminating the scene of interest 4b with an electromagnetic wave containing a known polarization (e.g. pure and known polarization) in a known space orientation given by E_{ref}.

The processing of the signal Yᵣ₁(t) observed by the second device 2 in the first time period and the signal Yᵣ₂(t) observed by the second device 2 in the second time period may be performed by the one or more processors 12. For this, the one or more processors 12 may obtain, from the second device 2, one or more third symbols (represented by the signal Yᵣ₁(t)) resulting from receiving the first electromagnetic wave with the first polarization P1 and one or more fourth symbols (represented by the signal Yᵣ₂(t)) resulting from receiving the second electromagnetic wave with the second polarization P2. The one or more processors 12 may compute the reference polarization by processing the one or more third symbols (represented by the signal Yᵣ₁(t)) and the one or more fourth symbols (represented by the signal Yᵣ₂(t)). In addition or alternatively, the one or more processors may be configured to perform channel estimation of the environment 4 by processing the one or more third symbols (represented by the signal Yᵣ₁(t)) and the one or more fourth symbols (represented by the signal Yᵣ₂(t)). In the above described example it is assumed that the device 1 is configured to wirelessly emit the second electromagnetic wave such that one or more symbols transmitted in the form of the second electromagnetic wave may be opposite to one or more symbols transmitted in the form of the first electromagnetic wave. That is, the signal representing the symbols transmitted in the form of the first electromagnetic wave reads as “Xᵢ₁” and the signal representing the symbols transmitted in the form of the second electromagnetic wave reads as “Xᵢ₂”, wherein Xᵢ₂=−Xᵢ₁. This is only by way of example and does not limit the present disclosure.

As outlined above, the one or more processors 12 may be configured to compute the reference polarization by at least one of processing, and combining, and applying a function to, the third electromagnetic wave (represented by the electric field Eᵣ₁) or any symbol (represented by the signal Yᵣ₁) resulting from receiving the third electromagnetic wave, and to the fourth electromagnetic wave (represented by the electric field Eᵣ₂) or any symbol (represented by the signal Yᵣ₂) resulting from receiving the fourth electromagnetic wave. In the above example described with regard to FIG. 5, the one or more processors 12 may compute the reference polarization by adding the third symbols represented by the signal Yᵣ₁ and the fourth symbols represented by the signal Yᵣ₂ (i.e. Yᵣ₂(t)+Yᵣ₁(t)).

According to an example, the device 1 may be a wireless transmitter device which, emits radio-frequency (RF) signals with unknown antenna polarization and/or unknown orientation is space. The polarizer device 3 may be a controllable polarizer device with known orientation in space, which is capable of altering the polarization pattern of an impinging signal by applying polarization filtering to at least two known polarization references P1 and P2. The second device 2 may be a wireless receiver device which receives RF signals (e.g. Yᵣ₁ and Yᵣ₂) propagated through the environment 4. The second device 2 may be configured to measure polarization of the received signals with respect to a local yet unknown coordinate system and/or relative polarization between two different signals.

The controller 11 may enable a signaling protocol between the device 1, the second device 2 and the polarizer device 3 to synchronize frame transmission with polarization filters of the polarizer device 3. This protocol can take place in a backhaul link or in the communication link. This signaling protocol allows ensuring that the wireless nodes operate jointly for coordinating the transmission of communication frames (e.g. RF communication frames) from one device (e.g. the device 1), with a polarization filtering applied on the polarizer device 3, and with a receiver device (e.g. the second device 2) that will receive the communication frames.

A physical (PHY) layer transmission protocol between the device 1, the second device 2, and the polarizer device 3 may realize a transmission scheme that will cancel interferences from the scattering introduced by the ambient environment 4, but excluding the one reflected by the polarizer device 3 on the scene of interest 4b. The cooperative scheme among the nodes, allows certain RF interference to be mitigated. In order to realize this scheme, the controller 11 may control the device 1 such that the RF communication frames are formed, by the device 1, so that RF signals not stemming or originating from the polarizer device 3 are cancelled at the second device 2, i.e. at the receiver side, e.g. after applying one or more linear combinations with or without the help of processing.

In the following another example regarding polarimetry sensing of a scene with a wireless transmitter device and a wireless receiver device is described with regard to FIG. 5, wherein the device 1 is the wireless transmitter device and the second device 2 is the wireless receiver device.

It is assumed that a wireless device (represented by the second device 2) equipped with a receiver desires to perform polarimetry sensing of a scene of interest 4b, and asks an illumination from a wireless transmitter device (represented by the device 1) and the assistance of the polarizer device 3. The device 1 transmits two consecutive signal sub-frames Xᵢ₁(t) and Xᵢ₂(t) synchronously with the change of states of the polarizer device 3.

$${X}_{i k} ( t ) = Re ( exp ( j 2 π ft ) {s}_{i k} ( t ) ) k ∈ \{ 1 , 2 \} ,$$

wherein “Sik” represent the symbols of the respective sub-frame Xik.

The frame structure may contain two contiguous parts, a time and phase synchronization frame, followed by a channel estimation frame. The channel estimation frame aims to estimate the matrix Mₛ representing the scene of interest 4b according to the illumination protocol performable by the device 1. This frame may be divided into two sub-frames.

Denoting k the index of the sub-frame, during sub-frame k, the second device 2 may observe a field Erk which can be written as

$${E}_{rk} ( t ) = {M}_{env} {E}_{ik} ( t )$$

Where Eᵢₖ is the field resulting from the transmitted signal Xᵢₖ and including the antenna characteristics at the transmitter side. The relation between Eᵢₖ and Xᵢₖ may be a linear operator, i.e.

$${E}_{ik} ( t ) = ℒ ( {X}_{ik} ( t ) )$$

The field impinging the antenna of the second device 2 after propagating in the ambient environment 4a may be written as

$${E}_{rk} ( t ) = {M}_{env} ℒ ( {X}_{ik} ( t ) )$$

The received frame at the receiver side (i.e. by the second device 2) may be written as

$${Y}_{rk} ( t ) = ℛ ( {M}_{env} {ℒ}_{tx} ( {X}_{ik} ( t ) )$$

For a signal received through the polarizer device 3 and illuminating the scene of interest 4b, the effect of the polarizer device 3 is represented with a matrix $ which has value Φk during sub-frame k∈{1,2}

$${Y}_{rk} ( t ) = ℛ ( {Φ}_{k} {M}_{s} {ℒ}_{tx} ( {X}_{ik} ( t ) )$$

Assuming a time and phase synchronization between the transmitter and the receiver (i.e. the device 1 and the second device 2), the combination of signals received through the ambient environment 4a and through the polarizer device 3 during the two sub-frames may be written as:

$${Y}_{r 1} ( t ) = ℛ ( ( {M}_{env} + {Φ}_{1} {M}_{s} ) {ℒ}_{tx} ( {X}_{i 1} ( t ) ) {Y}_{r 2} ( t ) = ℛ ( ( {M}_{env} + {Φ}_{2} {M}_{s} ) {ℒ}_{tx} ( {X}_{i 2} ( t ) )$$

Adding the signals of both sub-frames, the role of the polarizer device 3 and transmitting the two signals Xᵢ₁ and Xᵢ₂ while the polarizer device 3 adapts its polarization configuration to the respective signal as described above is to emulate the illumination with a known polarization wave, by choosing the polarizer matrices Φ₁ and Φ₂ such that (Φ₁-Φ₂) V=E_{ref} ∇V, wherein “V” may stand for any vector that represents any impinging polarity of an electric field. This may be implemented, by ensuring that the matrix (Φ₁-Φ₂) is a rank one matrix.

At an initial state, the transmitter device (i.e. device 1) may transmit a signal Xᵢ₁ generating an illumination with the electric field Ej. The receiver device (i.e. second device 2) may observe the field Eᵣ₁ as signal Yᵣ₁, which has resulted from the propagation of the electric field Eⱼ₁ in the environment 4, including reflections from the polarizer device 3. The received signal Yᵣ₁ is composed of signals with unknown polarization corresponding to the propagation through the ambient environment 4a and signals with a known first polarization P1 which have been reflected from the polarizer device 3 and illuminated the scene of interest 4b. At a second state, the transmitter device (i.e. device 1) may transmit a signal Xᵢ₂ generating an illumination with the electric field Eᵢ₂, e.g. Eᵢ₂=−Eᵢ₁. The receiver device (i.e. the second device 2) may observe the field Eᵣ₂ as signal Yᵣ₂, which has resulted from the same propagation (of the electric field Eᵢ₂) in the environment 4 as in the previous state, since the complete process may be executed within the same channel coherence time. The received signal Yᵣ₂ is composed of signals with an unknown polarization corresponding to the propagation through the ambient environment 4a and signals with a known second polarization P₂, which have been reflected from the polarizer device 3 and have illuminated the scene of interest 4b during the second sub-frame.

The combination of the signals of the two sub-frames may be written as

$$\begin{matrix}{Y}_{r 2} ( t ) + {Y}_{r 1} ( t ) = ℛ ( ( ( {M}_{env} + {Φ}_{1} {M}_{s} ) - ( {M}_{env} + {Φ}_{2} {M}_{s} ) ) {ℒ}_{tx} ( {X}_{i 1} ( t ) ) ) \\ = ℛ ( ( {Φ}_{1} - {Φ}_{2} ) {M}_{s} {ℒ}_{tx} ( {X}_{i 1} ( t ) ) )\end{matrix}$$

It includes only the contribution of the scene of interest 4b, and corresponds to a virtual illumination given by the polarization E_{ref}.

According to a further example, the one or more processors may perform a channel estimation (may be referred to as channel acquisition) of the ambient environment 4a.

For this the one or more processors 12 may obtain, from the second device 2, a third electromagnetic wave (represented by the electric field Eᵣ₁) resulting from the propagation of the electromagnetic wave with the first polarization P₁ and a fourth electromagnetic wave (represented by the electric field Eᵣ₂) resulting from the propagation of the electromagnetic wave with the second polarization P₂. The one or more processors 12 may be configured to compute the reference polarization by processing the third electromagnetic wave and the fourth electromagnetic wave. The electric fields Eᵣ₁ and Eᵣ₂ may be written as:

$${E}_{r 1} = {M}_{env} {E}_{i 1} + {M}_{s} {Φ}_{1} {E}_{i 1} \\ {E}_{r 2} = {M}_{env} {E}_{i 2} + {M}_{s} {Φ}_{2} {E}_{i 2}$$

The one or more processors 12 may perform the channel estimation of the environment 4 (e.g. the ambient environment 4a) by performing one or more linear combinations of the third electromagnetic wave (represented by the electric field Eᵣ₁) and the fourth electromagnetic wave (represented by the electric field Eᵣ₂).

For example, the one or more processors 12 may perform the channel estimation of the environment by subtracting the fourth electromagnetic wave from the third electromagnetic wave. This may be written with regard to the electric field Er representing the third electromagnetic wave and the electric field Eᵣ₂ representing the fourth electromagnetic wave as follows:

$$\begin{matrix}{E}_{r 1} - {E}_{r 2} = {M}_{env} {E}_{i 1} + {M}_{s} {Φ}_{1} {E}_{i 1} - {M}_{env} {E}_{i 2} - {M}_{s} {Φ}_{2} {E}_{i 2} \\ = {M}_{env} ( {E}_{i 1} - {E}_{i 2} ) + {M}_{s} ( {Φ}_{1} {E}_{i 1} - {Φ}_{2} {E}_{i 2} )\end{matrix}$$

In case it is assumed that the device 1 is configured to wirelessly emit the second electromagnetic wave (represented by the electric field Eᵢ₂) such that the second electromagnetic wave is opposite to the first electromagnetic wave (represented by the electric field Eᵢ₁) up to a certain synchronization in time, e.g. Eᵢ₁=Eᵢ and Eᵢ₂=−Eᵢ, the formula regarding the subtraction of the fourth electromagnetic wave from the third electromagnetic wave for channel estimation may read as follows:

$${E}_{r 1} - {E}_{r 2} {\underbrace{=}}_{{{{E}_{i 1}}_{{=}^{}} {E}_{i}}_{{{E}_{i 2}}_{{= -}^{}} {E}_{i}}} 2 {M}_{env} {E}_{i} + {M}_{s} {E}_{i} ( {Φ}_{1} + {Φ}_{2} )$$

In case it is additionally assumed, that the second polarization P2 is opposite to the first polarization P1, i.e. the matrix Φ₂ used by the polarizer device 3 for achieving the second polarization P2 is opposite to the matrix Φ₁ used by the polarizer device 3 for achieving the first polarization P1 (Φ₁=−Φ₂), the formula regarding the subtraction of the fourth electromagnetic wave from the third electromagnetic wave for channel estimation may read as follows:

$${E}_{r 1} - {E}_{r 2} {\underbrace{=}}_{{{{E}_{i 1}}_{{=}^{}} {E}_{i}}_{{{{E}_{i 2}}_{{=}^{}} - {E}_{i}}_{{Φ}_{1} = - {Φ}_{2}}}} 2 {M}_{env} {E}_{i}$$

Thus, the one or more processors 12 may perform channel estimation of the ambient environment 4a by performing the above described steps.

The above channel estimation may optionally be performed by the one or processors 12 using symbols resulting from receiving the electromagnetic wave with the first polarization P1 and symbols resulting from receiving the electromagnetic wave with the second polarization P2.

For this, for example, the one or more processors 12 may obtain, from the second device 2, one or more third symbols (represented by the received signal Yᵣ₁) resulting from receiving the electromagnetic wave with the first polarization P1 and one or more fourth symbols (represented by the received signal Yᵣ₂) resulting from receiving the electromagnetic wave with the second polarization P2. The one or more processors 12 may perform the channel estimation of the environment by processing the one or more third symbols and the one or more fourth symbols. For example, the one or more processors may perform the channel estimation of the environment by performing one or more linear combinations of the one or more fourth symbols and the one or more third symbols. For the aforementioned signal processing for channel estimation, it may be assumed that the one or more symbols transmitted in the form of the second electromagnetic wave (represented by the electric field Eᵢ₂) may be opposite to one or more symbols transmitted in the form of the first electromagnetic wave (represented by the electric field Eᵢ₁). Optionally, it may be assumed that the second polarization P2 is opposite to the first polarization P1, i.e. the matrix Φ₂ used by the polarizer device 3 for achieving the second polarization P2 is opposite to the matrix P1 used by the polarizer device 3 for achieving the first polarization P1 (Φ₁=−Φ₂).

In the light of the above, the system of any one of FIGS. 1, 2, 4 and 5 enables to measure the electromagnetic field (Eᵣ₁ or Eᵣ₂) resulting from illuminating a selected scene 4b with known polarization (P1 or P2) while eliminating the contamination resulting from illumination of an ambient environment 4a that produces non-controlled polarization. One of the application enabled by these features is to offer signals (Yᵣ₁ or Yᵣ₂) resulting from illumination with known reference polarization that may be processed (e.g. by the one or more processors 12) subsequently for remote sensing applications.

The service may be provisioned by an apparatus with known and controlled properties, namely the polarizer device 3, and a method relying on controlling the incident electric fields (Eᵢ₁ or Eᵢ₂) synchronously with the polarizer device 3. That is, a first electromagnetic wave represented by the electric field Ein may be emitted by the device 1 when the polarizer device 3 is configured to change a polarization of an impinging wave to the first polarization P1. Accordingly, a second electromagnetic wave represented by the electric field Eᵢ₂ may be emitted by the device 1 when the polarizer device 3 is configured to change a polarization of an impinging wave to the second polarization P2. The wireless devices that may be involved in the application may be synchronized with the timing for providing the respective service. The polarizer filter 3 may be (but is not limited to) a fixed device that is capable of polarization filtering (such as a reflective controllable surface) with known orientation in space and with reflective properties controlled by/under the control of the controller 11.

The systems of FIGS. 1, 2, 4 and 5 may exploit a radio-frequency (RF) illumination using an electromagnetic wave with unknown polarization to obtain the result of a new RF illumination with known polarization using a single device in the form of the polarizer device 3. Extracting this signal with a priori known polarization offers a reference signal that can be used to observe and analyses relatively the perceived RF signals coming from the propagation environment.

Advantages of the systems according to FIGS. 1, 2, 4 and 5 comprise that the polarization reference may be provided by a single device in the form of the polarizer device 3. Other devices, such as the device 1 and the second device 2, do not need to be aware of spatial orientation and antenna polarization. A single device in the form of the polarizer device 3, which is part of the infrastructure, may be capable of providing a supplementary information to the device 1 and the second device 2, e.g. which may be client wireless nodes, as a service. The disclosed systems allow eliminating interference stemming or originating from the ambient environment 4a. The disclosed systems allow a large range of wireless devices to use the service, thus, enabling these devices to perform sensing applications based on polarimetry.

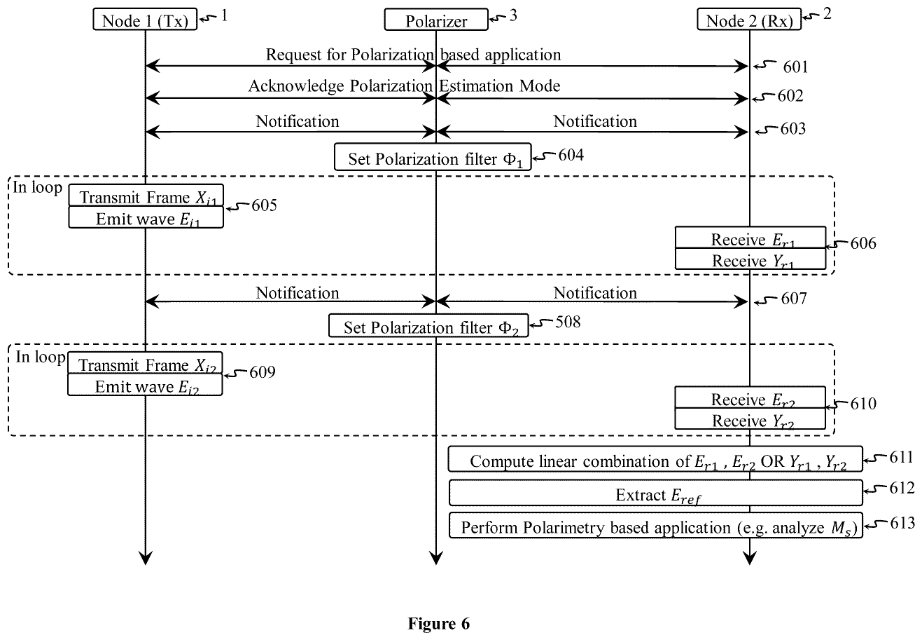

FIG. 6 shows an example of a method according to an embodiment of this disclosure. The method of FIG. 6 is an example of the method of FIG. 3. Thus, the description of the method of FIG. 3 is valid for the method of FIG. 6. The method is described with regard to the devices of the system of FIG. 5. This is only by way of example and does not limit the present disclosure. Thus, the description is correspondingly valid for any other system according to the first aspect of this disclosure, such as any one of the systems of FIGS. 1, 2 and 4.

For the method of FIG. 6 it is assumed that the device 1 is a first node “Node 1”. The first node may be a transmitter node Tx, i.e. the device 1 is assumed to be a wireless transmitter device. The second device 2 is assumed to be a second node “Node 2”. The second node may be a receiver node Rx, i.e. the second device 2 is assumed to be a wireless receiver device. The first node “Node 1” and second node “Node 2” may be part of a wireless network, such as wireless communication network. The wireless communication network may be a radio-frequency (RF) communication network, i.e. communication in the network between nodes is performed using radio-frequency electromagnetic waves. The polarizer device 3 may be a third node. The third node may be part of the wireless network. The polarizer device 3 may be referred to as communication infrastructure device.

As shown in FIG. 6, in a first step 601 of the method an initiating device among the device 1, the second device 2 and the polarizer device 3 initiates (transmits, optionally broadcasts) a request to perform polarization estimation to other nodes, i.e. to the other devices. Optionally, in the first step 601 the controller 11 initiates the request to perform polarization estimation to the device 1, the second device 2 and the polarizer device 3. In a second step 602, the initiating device, optionally the controller 11, awaits for acknowledgement from the other nodes, i.e. from the other devices.

In an optional third step 603, the device 1, the second device 2 or the controller 11 may provide first configuration information to the polarizer device 3. The polarizer device 3 may be configured to, in response to obtaining the first configuration information, change the polarization of an electromagnetic wave impinged on the polarizer device to the first polarization P1. In other words, the device 1, the second device 2 or the controller 11 may configure the polarizer device 3 to use the polarization filtering matrix Φ₁ on an impinging electromagnetic wave, reflecting an electromagnetic wave or signals with the known first polarization P1 (may be referred to as known polarization reference P1), for example during a first sub-frame being wirelessly transmitted from the device 1 to the second device 2. As a result, in a fourth step 604 the polarizer device 3 is configured to apply polarization filtering matrix Φ₁ on an impinging electromagnetic wave, reflecting an electromagnetic wave or signals with the known first polarization P1.

In a fifth step 605, e.g. during the first sub-frame, the device 1 (optionally with an unknown antenna polarization and unknown orientation in space) emits a first signal Xᵢ₁ by emitting a first electromagnetic wave that may be represented by a first electric field Eᵢ₁. The controller 11 may control the device 1 to emit the first signal Xᵢ₁. In a sixth step 606, e.g. during the first sub-frame, the second device 2 receives a signal Yᵣ₁ including a signal propagated through the ambient environment 4a and a signal through the polarizer device 3. The second device 2 may receive the signal Yᵣ₁ by receiving an electromagnetic wave that may be represented by an electric field Eᵣ₁, wherein the electromagnetic wave comprises an electromagnetic wave propagated through the ambient environment 4a and an electromagnetic wave with the first polarization P1 that is reflected from the polarizer device 3. Optionally, the second device 2 notifies the device 1 and the polarizer device 3 that it has received the signal Yᵣ₁. As shown in FIG. 6, the fifth step 605 and sixth step 606 may optionally be repeated one or more times to enhance the received signal Yᵣ₁.

In an optional seventh step 607 the device 1, the second device 2 or the controller 11 may provide second configuration information to the polarizer device 3. The polarizer device 3 may be configured to, in response to obtaining the second configuration information, change the polarization of an electromagnetic wave impinged on the polarizer device 3 to the second polarization P2. In other words, the device 1, the second device 2 or the controller 11 may configure the polarizer device 3 to use the polarization filtering matrix Φ₂ on an impinging electromagnetic wave, reflecting an electromagnetic wave or signals with the known second polarization P2 (may be referred to as known polarization reference P2), for example during a second sub-frame being wirelessly transmitted from the device 1 to the second device 2. As a result, in an eighth step 608 the polarizer device 3 is configured to apply polarization filtering matrix Φ₂ on an impinging electromagnetic wave, reflecting an electromagnetic wave or signals with the known second polarization P2. The polarization filtering matrix Φ₂ is different to the polarization filtering matrix Φ₁ and, thus, the known second polarization P2 is different to the known first polarization P1.

In a ninth step 609, e.g. during the second sub-frame, the device 1 emits a second signal Xᵢ₂ by emitting a second electromagnetic wave that may be represented by a second electric field Eᵢ₂. The controller 11 may control the device 1 to emit the second signal Xᵢ₂. In a tenth step 510, e.g. during the second sub-frame, the second device 2 receives a signal Yᵣ₂ including a signal propagated through the ambient environment 4a and a signal through the polarizer device 3. The second device 2 may receive the signal Yᵣ₂ by receiving an electromagnetic wave that may be represented by an electric field Eᵣ₂, wherein the electromagnetic wave comprises an electromagnetic wave propagated through the ambient environment 4a and an electromagnetic wave with the second polarization P2 that is reflected from the polarizer device 3. Optionally, the second device 2 notifies the device 1 and the polarizer device 3 that it has received the signal Yᵣ₂. As shown in FIG. 6, the ninth step 609 and tenth step 610 may optionally be repeated one or more times to enhance the received signal Yᵣ₂.

Optionally, the third step 603 and the seventh step 607 may be omitted. In this case, the controller 11 may control the polarizer device 3 to change, in a first time slot, the polarization of an electromagnetic wave impinged on the polarizer device to the first polarization P1. The controller 11 may be configured to control the polarizer device 3 to change, in a second time slot successive to the first time slot, the polarization of an electromagnetic wave impinged on the polarizer device to the second polarization P2. In other words, the polarizer device 3 may be controlled by a time control (i.e. dependent on time) with regard to whether the polarization of the impinged electromagnetic wave is changed to the first polarization P1 or the second polarization P2. Thus, the fourth step 604 and the eight step 608 may be performed dependent on a time control. In the aforementioned case, the controller 11 may control the device 1 to perform the fifth step 605 in the first time slot and to perform the ninth step 609 in the second time slot. That is, the fifth step 605, sixth step 606, ninth step 609 and tenth step 610 may be controlled by the aforementioned time control.

In an eleventh step 611, the one or more processors 12 may process the received electric fields Eᵣ₁ and Eᵣ₂ or received signals Yᵣ₁ and Yᵣ₂ by applying a linear operation. For this, the one or more processors 12 may obtain the received electric fields Eᵣ₁ and Eᵣ₂ or received signals Yᵣ₁ and Yᵣ₂ from the second device 2. In a twelfth step 612, the one or more processors may add the received electric fields Eᵣ₁ and Eᵣ₂ or received signals Yᵣ₁ and Yᵣ₂ to extract a known polarization E_{ref} and perform polarimetry sensing. In a thirteenth step 613, the one or more processors 12 may perform a polarimetry based application, e.g. by estimating a matrix Mₛ representing the depolarization of the scene of interest 4a with respect to the reference polarization E_{ref}. Optionally, in a further step, the one or more processors may subtract the received electric fields Eᵣ₁ and Eᵣ₂ or received signals Yr and Yᵣ₂ from each other to perform channel estimation of the ambient environment 4a. Optionally, in a furthermore step, the one or more processors 12 may perform a polarimetry based application, e.g. by estimating a matrix Meny representing the scatterers of the ambient environment 4a. The eleventh step 611, the twelfth step 612, the thirteenth step 613, the aforementioned further step and aforementioned furthermore step may be performed in any order. Optionally, the second device 2 or the controller 11 may notify the polarizer device 3 and the device 1 to restart the procedure of FIG. 6 from the third step 603 (or the fourth step 604 in case the step 603 is not part of the method of FIG. 6).

In an optional variation of the method of FIG. 6, the optional third step 603 and optional seventh step 607 may be omitted and in a step after the second step 602 and before the fourth step 604 the device 1, second device 2, or the polarizer device 3 may send a single notification to the other devices (i.e. other nodes), where a defined time frame is allocated for transmitting the signal Xi with polarization filter P1 of the polarizer device 3, and second time frame is allocated for transmitting the signal Xᵢ₂ along with polarization filter P2 of the polarizer device 3. The time frames may be separated with a defined guard interval. Optionally, the controller 11 may send the single notification to the deice 1, second device 2 and the polarizer device 3. In an optional variation of the method of FIG. 6, in the step after the second step 602 and before the fourth step 604 the polarizer device 3 may send the single notification to the device 1 and the second device 2 (i.e. the other nodes). In an optional variation of the method of FIG. 6, in the step after the second step 602 and before the fourth step 604 the device 1 may send the single notification to the second device 2 and the polarizer device 3 (i.e. the other nodes). The terms “send” and “transmit” may be used as synonyms.

In an optional variation of the method of FIG. 6, the device 1 (i.e. the transmitter node) and the second device 2 (i.e. receiver node) may switch roles. For this, a signaling message exchange may indicate to the wireless nodes a request to switch role and a confirmation from other nodes to the requesting node. The controller 11 may optionally control the switch of roles.

In an optional variation of the method of FIG. 6, the data and information received by the second device 2 (i.e. the receiver node) may be feedback as calibration information to the device 1 (i.e. the transmitter node). The device 1 may use the feedback information to calibrate itself.

In an optional variation of the method of FIG. 6, there may be multiple receiver nodes (i.e. there may be a plurality of the second device 2). The receiver nodes may be notified by the polarizer device 3 or the controller 11 to transit to the next sub-frame context. Each receiver node (e.g. a processor of each receiver node) may perform its channel estimation independently.

In an optional variation of the method of FIG. 6, there may be multiple transmitter nodes (i.e. there may be a plurality of the device 1). The transmitter nodes may have unknown antenna polarizations. Each transmitter node may generate an illumination electromagnetic wave with its own polarization pattern. The transmitter nodes may be notified by the polarizer device 3 or the controller 11 to transit to the next sub-frame context. All signals reflected by the polarizer device 3 have known polarizations (e.g. pure and known polarizations). The second device 2 (i.e. the receiver node) or the one or more processors 12 may combine signals from the first sub-frame and the second sub-frame to cancel signals not stemming or originating from the polarizer device 3. The second device 2 or the one or more processors 12 may extract a known polarization E_{ref}.

Above descriptions with regard to sub-frames may be correspondingly valid for other signal objects.

In the light of the above, the present disclosure comprises several concepts. For example, one concept is directed to a configuration of the device (e.g. a transmitter) for wirelessly emitting a first and second electromagnetic wave e.g. with a specific configuration of emitting the second electromagnetic wave with respect to emitting the first electromagnetic wave. A further concept may be directed to a configuration of the polarizer device for changing the polarization of the first electromagnetic wave to a first polarization and the polarization of the second electromagnetic wave to a second polarization. A furthermore concept may be directed to the processing of the aforementioned emissions of electromagnetic waves via the polarizer device, e.g. processing of a third electromagnetic wave and fourth electromagnetic wave/one or more third symbols and one or more fourth symbols (e.g. signals) resulting from the propagation of the electromagnetic wave with the first polarization and the propagation of the electromagnetic wave with the second polarization, respectively. Optionally, the processing may be performed as one or more linear combinations on the third electromagnetic wave and fourth electromagnetic wave/one or more third symbols and one or more fourth symbols (e.g. signals).

The present disclosure has been described in conjunction with various embodiments as examples as well as implementations. However, other variations can be understood and effected by those persons skilled in the art and practicing the claimed matter, from the studies of the drawings, this disclosure and the independent claims. In the claims as well as in the description the word “comprising” does not exclude other elements or steps and the indefinite article “a” or “an” does not exclude a plurality. A single element or other unit may fulfill the functions of several entities or items recited in the claims. The mere fact that certain measures are recited in the mutual different dependent claims does not indicate that a combination of these measures cannot be used in an advantageous implementation.

1. A system for at least one of determining a reference polarization, performing channel estimation of an environment (4) and sensing the environment, wherein
the system comprises a controller (11), one or more processors (12), a polarizer device (3), and a device (1);
the device (1) is configured to wirelessly emit a first electromagnetic wave (5, 5a, 5b, Eᵢ₁) such that the first electromagnetic wave (5, 5a, 5b, Eᵢ₁) impinges on the polarizer device (3) and on a second device (2), and a second electromagnetic wave (5, 5a, 5b, Eᵢ₂) such that the second electromagnetic wave (5, 5a, 5b, Eᵢ₂) impinges on the polarizer device (3) and on the second device (2);
the controller (11) is configured to control the polarizer device (3) to change a polarization of the first electromagnetic wave (5, 5a) impinged on the polarizer device (3) to a first polarization (P1), such that the first electromagnetic wave (6) with the first polarization (P1) impinges on the second device (2);
the controller (11) is configured to control the polarizer device (3) to change a polarization of the second electromagnetic wave (5, 5a) impinged on the polarizer device to a second polarization (P2), such that the second electromagnetic wave (6) with the second polarization (P2) impinges on the second device (2); and
the one or more processors (12) are configured to determine the reference polarization, perform the channel estimation and/or sense the environment based on the first electromagnetic wave with the first polarization and the second electromagnetic wave with the second polarization.

2. The system according to claim 1, wherein
the controller (11) is configured to provide first configuration information and/or second configuration information to the polarizer device (3); and wherein
the polarizer device (3) is configured to, in response to obtaining the first configuration information, change the polarization of an electromagnetic wave (5, 5a) impinged on the polarizer device (3) to the first polarization (P1); and/or
the polarizer device (3) is configured to, in response to obtaining the second configuration information, change the polarization of an electromagnetic wave (5, 5a) impinged on the polarizer device (3) to the second polarization (P2).

3. The system according to claim 1, wherein
the controller (11) is configured to control the polarizer device (3) to change, in a first time slot, the polarization of an electromagnetic wave (5, 5a) impinged on the polarizer device (3) to the first polarization (P1); and
the controller (11) is configured to control the polarizer device (3) to change, in a second time slot successive to the first time slot, the polarization of an electromagnetic wave (5, 5a) impinged on the polarizer device (3) to the second polarization (P2).

4. The system according to claim 1, wherein
the device (1) is configured to wirelessly emit one or more first symbols for generating the first electromagnetic wave (5, 5a, 5b, Eᵢ₁), and one or more second symbols for generating the second electromagnetic wave (5, 5a, 5b, Eᵢ₂).

5. The system according to claim 1, wherein
the controller (11) is configured to provide a first control message and/or a second control message to the device (1); and wherein
the device (1) is configured to, in response to receiving the first control message, emit the first electromagnetic wave (5, 5a, 5b, Eᵢ₁); and
the device (1) is configured to, in response to receiving the second control message, emit the second electromagnetic wave (5, 5a, 5b, Eᵢ₂).

6. The system according to claim 1, wherein
the controller (11) is configured to control the device (1) to wirelessly emit, in a first time slot, the first electromagnetic wave (5, 5a, 5b, Eᵢ₁); and
the controller (11) is configured to control the device (1) to wirelessly emit, in a second time slot successive to the first time slot, the second electromagnetic wave (5, 5a, 5b, Eᵢ₂).

7. The system according to claim 1, wherein
the one or more processors (12) are configured to obtain, from the second device (2), a third electromagnetic wave (6, Eᵣ₁) resulting from the propagation of the electromagnetic wave (6) with the first polarization (P1) and a fourth electromagnetic wave (6, Eᵣ₂) resulting from the propagation of the electromagnetic wave (6) with the second polarization (P2); and
compute the reference polarization by processing the third electromagnetic wave and the fourth electromagnetic wave.

8. The system according to claim 7, wherein
the one or more processors (12) are configured to compute the reference polarization by at least one of processing, and combining, and applying a function to, the third electromagnetic wave (6, Eᵣ₁) or any symbol resulting from receiving the third electromagnetic wave, and to the fourth electromagnetic wave (6, Eᵣ₂) or any symbol resulting from receiving the fourth electromagnetic wave.

9. The system according to claim 7, wherein the system comprises the second device (2), and at least one of the processors (12) configured to compute the reference polarization is included in the second device (2).

10. The system according to claim 1, wherein
the one or more processors (12) are configured to obtain, from the second device (2), one or more third symbols resulting from receiving the electromagnetic wave (6) with the first polarization (P1) and one or more fourth symbols resulting from receiving the electromagnetic wave (6) with the second polarization (P2); and
perform the channel estimation of the environment (4) and/or sense the environment (4) by processing the one or more third symbols and the one or more fourth symbols.

11. The system according to claim 7, wherein
the one or more processors (12) are configured to perform the channel estimation of the environment (4) and/or sense the environment by performing one or more linear combinations of the one or more fourth symbols and the one or more third symbols, and/or
the one or more processors (12) are configured to perform the channel estimation of the environment (4) and/or sense the environment by performing one or more linear combinations of the third electromagnetic wave and the fourth electromagnetic wave.

12. The system according to claim 10, wherein at least one of the processors (12) configured to perform the channel estimation and/or sense the environment (4) is included in the device (1).

13. The system according to claim 7, wherein
the second device (2) is configured to provide the one or more third symbols or the third electromagnetic wave (6, Eᵣ₁) and the one or more fourth symbols or the fourth electromagnetic wave (6, Eᵣ₂) to the one or more processors (12).

14. The system according to claim 1, wherein the one or more processors (12) are configured to perform an object sensing of an object based on the first electromagnetic wave (5, 5a, 5b, Eᵢ₁) and the second electromagnetic wave (5, 5a, 5b, Eᵢ₂).

15. The system according to claim 14, wherein at least one of the processors (12) configured to perform the object sensing is included in the polarizer device (3).

16. A method for at least one of determining a reference polarization, performing channel estimation of an environment (4) and sensing the environment (4), wherein the method comprises
wirelessly emitting (301), by a device, a first electromagnetic wave such that the first electromagnetic wave impinges on a polarizer device and on a second device;
changing (302), by the polarizer device, a polarization of the first electromagnetic wave impinged on the polarizer device to a first polarization, and transferring the first electromagnetic wave with the first polarization such that the first electromagnetic wave with the first polarization impinges on the second device;
wirelessly emitting (303), by the device, a second electromagnetic wave, such that the second electromagnetic wave impinges on the polarizer device and on the second device; and
changing (304), by the polarizer device, a polarization of the second electromagnetic wave impinged on the polarizer device to a second polarization, and transferring the second electromagnetic wave with the second polarization such that the second electromagnetic wave with the second polarization impinges on the second device.
